(19) United States
(12) Patent Application Publication
(10) Pub. No.: US 2017/0144694 A1
(43) Pub. Date: May 25, 2017

(54) Steering System of a Two-Track Vehicle

(71) Applicant: Bayerische Motoren Werke Aktiengesellschaft, Muenchen (DE)

(72) Inventor: Matthias STANGL, Dachau (DE)

(21) Appl. No.: 15/426,238

(22) Filed: Feb. 7, 2017

Related U.S. Application Data
(63) Continuation of application No. PCT/EP2015/067623, filed on Jul. 31, 2015.

(30) Foreign Application Priority Data
Aug. 19, 2014 (DE) 10 2014 216 462.1

(51) Int. Cl. B62D 5/04; B62D 7/09; B62D 7/20

(52) U.S. Cl. CPC B62D 5/0424; B62D 7/20; B62D 7/09; B62D 17/00

(57) ABSTRACT

A steering system of a two-track vehicle has a control rod which is displaceable transverse to the longitudinal axis of the vehicle, and track rods coupled at the two ends of the control rod, which act on steerable wheels of the vehicle such that the wheels are pivoted around the steering axis of rotation by a displacement of the control rod. The control rod is configured divided into two control rod parts each assigned to a wheel and connected to each other via a coupling member which braces the two control rod parts against each other at least temporarily, and at least temporarily enables a relative movement of the two control rod parts in the transverse direction of the vehicle. The coupling member is connected to each of the control rod parts via screw threads. The screw axis of rotation of the screw threads is the longitudinal axis of the control rod. The control rod parts and/or the coupling member are rotatable around the longitudinal axis.

### CROSS REFERENCE TO RELATED APPLICATIONS

This application is a continuation of PCT International Application No. PCT/EP2015/067623, filed Jul. 31, 2015, which claims priority under 35 U.S.C. §119 from German Patent Application No. 10 2014 216 462.1, filed Aug. 19, 2014, the entire disclosures of which are herein expressly incorporated by reference.

### BACKGROUND AND SUMMARY OF THE INVENTION

The invention relates to a steering system of a two-track vehicle, having a control rod which is displaceable transversely with respect to the vehicle longitudinal axis and to the two ends of which there are articulatedly connected track rods which act on the steerable wheels of the vehicle, such that, with a displacement of the control rod, the wheels are pivoted about their steering axis of rotation. The control rod is designed so as to be split into two control rod parts assigned to, in each case, one wheel, which control rod parts are connected to one another by way of a coupling element which at least intermittently supports the two control rod parts relative to one another and at least intermittently permits a relative movement of the two control rod parts in a vehicle transverse direction. With regard to the prior art, reference is made in particular to DE 199 02 556 A1 and also to DE 10 2012 219 888 A1 or EP 2 759 458 A1.

Simple common steering systems of vehicles have a unipartite control rod, which, in the case of so-called toothed-rack steering gears, is in the form of a toothed rack. The teeth of the toothed rack are engaged on by the steering spindle, which is actuated by the driver of the vehicle by way of his or her steering wheel, via a pinion. Also known for steering systems of two-track vehicles are the so-called steering trapezoid or the Ackermann relationship, whereby, for a common actuation of the two steerable wheels of an axle of a two-track vehicle, a certain relationship between the steer angle of the wheel at the inside of the curve and of the wheel at the outside of the curve of the vehicle should be maintained to the greatest possible extent in order to keep the steering power demand and the tire wear as low as possible. In a known manner, it is possible by way of a fixed steering trapezoid for the kinematic target curve of the two steerable wheels of an axle to be achieved exactly only at two points.

One possibility for positioning the two steerable wheels of the axle of a two-track vehicle relative to one another in such a way for all possible wheel steer angles or steer angles of the vehicle such that the Ackermann relationship is adhered to consists in providing, for each steerable wheel, a dedicated control motor or the like, by way of which the respective wheel steer angles are set in a manner individually adapted to one another. However, such a solution (in the form of a steer-by-wire steering system) is not only energy-intensive but also cumbersome, because suitable measures must be provided for a possible failure even of only one control motor. If a suitable coupling element is provided between two wheel-specific control rod parts, which coupling element is referred to as a telescopic rod arrangement in FIG. 2 of DE 199 02 556 A1, the problem is alleviated.

Nevertheless, on a vehicle steering system of the type described above, functional improvements are possible and addressed by the present invention.

An improvement is distinguished by the fact that the coupling element is connected by way of, in each case, one screw thread, the screw axis of rotation of which is the longitudinal axis of the control rod, to the control rod parts, and the control rod parts and/or the coupling element are/is rotatable about said longitudinal axis. Furthermore, a steering spindle, which is connected to a steering wheel for the driver, meshes with the coupling element such that a rotation of the steering spindle causes a displacement of the coupling element in the vehicle transverse direction.

In the present case, it is thus possible for each steerable wheel to be assigned a dedicated control motor (in the present case, for the sake of simple actuation, an electric motor is proposed, though the general principle of the present invention may likewise be realized using hydraulic motors or other control motors), such that steer angles can be set individually for each wheel of the steerable vehicle axle, though said two steerable wheels are at least intermittently connected to one another by way of the control rod, such that, in the event of a failure of one of the (two) control or electric motors, the other control or electric motor can perform the function thereof. For this purpose, the control rod is of split design and is configured such that the first control rod part (for example of the left-hand vehicle wheel) can be supported on the second control rod part (for example of the right-hand vehicle wheel), and/or such that the two control rod parts are couplable to one another, but are alternatively also adjustable independently of one another. For the latter case, each control rod part is assigned a dedicated control or electric motor. Here, it is expressly pointed out that in each case one dedicated control motor per control rod part is not an imperative feature, even though the present invention can thus be realized in a particularly simple manner and in a manner particularly convenient for the driver of the vehicle. By contrast, it is essential that the control rod is of correspondingly split design and the two control rod parts are displaceable either jointly, supported on one another, or alternatively separately from one another, and thus relative to one another in the vehicle transverse direction.

A steering system according to the invention can be realized in a functionally reliable manner if the coupling element is connected by way of, in each case, one screw thread, the screw axis of rotation of which is the longitudinal axis of the control rod, to the control rod parts. The control rod parts and/or the coupling element are/is rotatable about the longitudinal axis. It is then specifically possible, for example by virtue of the coupling element being rotated about the screw axis of rotation, for the spacing, measured in the vehicle transverse direction, between those ends of the control rod parts which face toward one another, to be varied. The coupling element is provided between the two control rod parts and which, in sections, overlaps those ends of the control rod parts which face toward one another so as to realize the screw thread connection. Thereby the steering trapezoid of the vehicle is inevitably changed, such that in this way, the Ackermann relationship can be maintained for all vehicle steer angles. By rotating, for example, the coupling element relative to the two control rod parts, these can thus be displaced relative to one another as viewed in a vehicle transverse direction, in any case when the screw thread between the left-hand control rod part and the coupling element differs from the screw thread between the right-hand control rod part and the coupling element. The above-described kinematic behavior may, however, also be realized by virtue of one control rod part or both control rod parts being rotated differently with respect to one another relative to the static coupling element, wherein, in the latter case, the screw thread on the left-hand control rod part and the screw thread on the right-hand control rod part do not need to differ from one another.

Furthermore, the greatest possible functional reliability is achieved if a steering spindle, which is connected to a steering wheel for the driver, meshes with the coupling element by way of a suitable geared connection such that a rotation of the steering spindle causes a displacement of the coupling element in the vehicle transverse direction. Then, a steering demand input by the driver using the steering wheel is simultaneously transmitted mechanically (and thus in fail-safe fashion) by way of the coupling element to the two control rod parts equally and thus to the steerable vehicle wheels. Owing to a relative movement between at least one control rod part and the coupling element, the control rod parts can be displaced relative to one another and thus differently in a vehicle transverse direction. For example, the coupling element, which is in the form of a sleeve, may for this purpose have not only an internal thread for the connection to the control rod parts but also a suitable external thread for the motion-transmitting connection to the steering spindle. It is self-evidently also possible for such a functional combination of the coupling element to be realized for another embodiment of the present invention, in which the coupling element is not connected by way of a screw thread to the control rod parts. Alternatively, the coupling element may project, by way of its ends which face toward the control rod parts and which are equipped with a suitable external screw thread, into these (control rod parts) if those end sections of the control rod parts which face toward the coupling element are of sleeve-like form with a corresponding internal screw thread, which screw thread may furthermore also, for example, be in the form of a ball screw.

As regards the individual displacement of each control rod part of a steering system according to the invention, it is possible for this purpose for each control rod part to be provided with a dedicated assistance motor which assists the driver when steering and introduces an assistance torque into the steering system. If the two assistance motors, which, with regard to simple controllability, preferably in the form of electric motors, are actuated differently, it is the case, when the control rod parts are not fully coupled by way of the coupling element, that different steer angles at the two steerable vehicle wheels can be easily realized. If one of the two assistance motors fails, it is merely necessary to ensure adequate coupling of the control rod parts by way of the coupling element, which can however be maintained particularly easily if, as already described above, the coupling element is connected to the control rod parts by way of in each case one screw thread, the screw axis of rotation of which is the longitudinal axis of the control rod.

In this context, it is particularly advantageous if each of the assistance motors (or electric motors or generally control motors) acts via a ball screw on the associated control rod part with or for a displacement thereof. At any rate, it is then the case that no further control element or the like is required on the coupling element, and, in this way, a simple and reliable steering system of a two-track vehicle is provided, which makes it possible for desired steer angles to be set independently of one another at the two wheels. Here, it is particularly expediently possible—as likewise already mentioned—for a steering spindle, which is mechanically connected to the steering wheel for the driver, to mechanically mesh, by way of a suitable gearing, with the coupling element and displace the latter in the vehicle transverse direction in accordance with the driver demand. For the sake of safety, it should always be possible for the driver to override the torque introduced by the assistance motors (or control motors) by way of a manually input torque. As an alternative to the above statements, it is however also possible, for example, for an electric-motor-imparted assistance torque to be introduced into the steering system via the steering spindle, wherein then, some suitable control element must be provided with the aid of which the coupling element is displaced in the respectively desired manner relative to at least one of the control rod parts in order to realize the desired functionality, specifically a wheel-specific steer angle adjustment on a two-track vehicle. Furthermore, it is expressly pointed out that a steering system according to the invention may also be configured entirely without the possibility of a mechanical steering intervention by the driver, wherein then, no steering spindle acts on the coupling element, and thus the coupling element cannot be displaced by the action of the driver, but rather only by at least one of the assistance motors or control motors. In this way, it is for example possible for a steering system to be formed on the vehicle rear axle.

Furthermore, a suitably designed switchable clutch element may also be provided, with the aid of which—for example actuated or switched by an actuator of arbitrary design—a decoupling which permits the relative movement between the two control rod parts, or alternatively a coupling of the control rod parts which permits the support on one another, or a partial decoupling of the control rod parts, is realized. For this purpose, the coupling element between the two control rod parts is either connected to or separated from at least one control rod part—specifically if a rigid connection is provided between the coupling element and the other control rod part—or is connected to or separated from both control rod parts, in terms of force transmission. The connection or separation can be realized by way of the clutch element, which is suitably actuable for example by way of an actuator. The latter actuator in turn may be actuated in accordance with demand by a suitable electronic control unit.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a highly schematic diagram of a steering system having a control rod according to an embodiment of the invention, wherein FIG. 1 is a view in a direction perpendicular to a roadway on which the vehicle is standing.

FIG. 2 is a highly schematic diagram of FIG. 1 in which parts of the control rod are illustrated in cross-section.

### DETAILED DESCRIPTION OF THE DRAWINGS

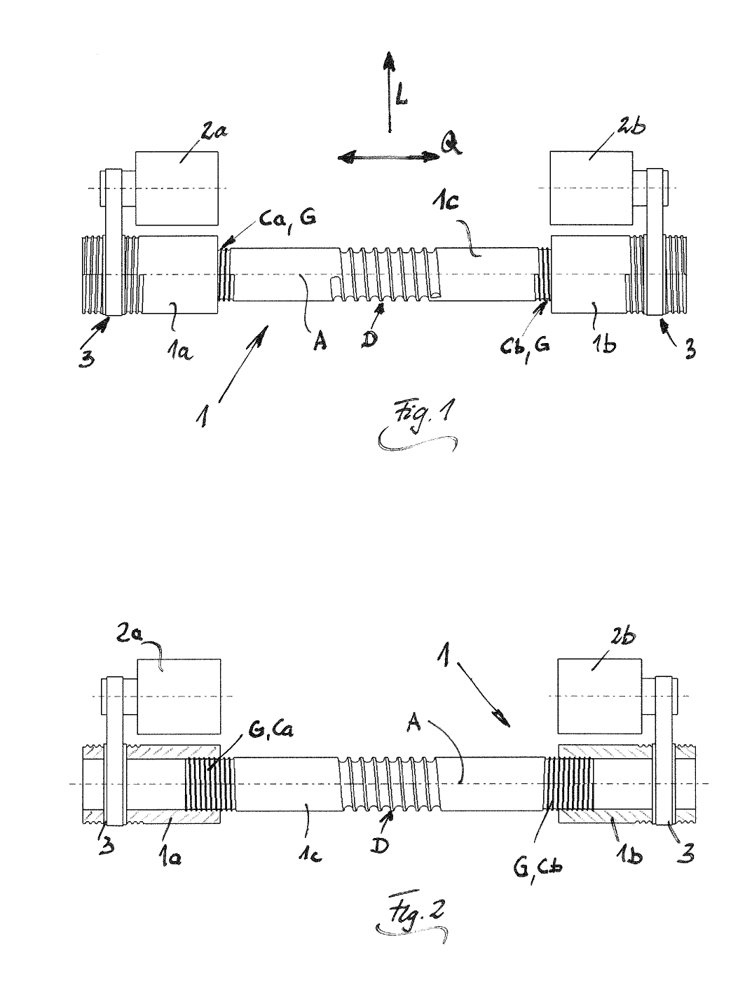

Merely one of several possible exemplary embodiments is illustrated in substantially abstracted form in the appended diagrammatic sketches (FIG. 1 shows a view with a viewing direction perpendicular to the roadway on which the vehicle is standing; FIG. 2 illustrates the control rod parts in section), and will be discussed below in addition to the description above.

The reference designation 1 denotes, as a whole, a control rod which is displaceable transversely with respect to the longitudinal axis L of a two-track vehicle (for example a passenger motor vehicle). The control rod 1 is composed of substantially three individual parts, specifically a first control rod part 1a, situated on the left in the illustration in the figure, a second control rod part 1b, situated on the right in the illustration in the figure, and a coupling element 1c, which connects the two control rod parts 1a, 1b to one another. Here, of the two control rod parts 1a, 1b, in each case only one section, which overlaps the coupling element 1c, is illustrated, and each control rod part 1a, 1b extends further away from the coupling element 1c to the right and to the left. Both the coupling element 1c and the two control rod parts 1a, 1b are of substantially circular cylindrical form and have a common cylinder axis or longitudinal axis A (or axis of rotation A) extending in a vehicle transverse direction Q.

Each of the mutually averted ends of the control rod parts 1a and 1b, that is to say the left-hand end, not shown in the figure, of the (left-hand) control rod part 1a and the right-hand end, not shown in the figure, of the (right-hand) control rod part 1b is connected by way of a steering-knuckle arm or the like, in a manner known to a person skilled in the art, via a track rod or the like to a steerable wheel (likewise not shown here) of the vehicle, in such a way that a displacement of the respective control rod part 1a or 1b in the vehicle transverse direction Q effects a pivoting of the respective wheel about the steering axis of rotation thereof (also referred to as spreading axis).

Those end sections of the control rod parts 1a, 1b which face toward the coupling element 1c are in the form of a sleeve with a circular-ring-shaped cylindrical cross section, into the respective inner wall of which there is formed a screw thread G. By way of said screw thread G. Each control rod part 1a, 1b is supported on the coupling element 1c by virtue of the coupling element 1c having, on the outside of its end sections Ca, Cb at both sides, a counterpart screw thread G, and partially projecting by way of said end sections Ca, Cb, or being screwed by way of the screw thread G, into the respective sleeve-shaped end section of the respective control rod part 1a, 1b. The screw thread G in the end section Ca of the coupling element 1c meshes with the corresponding screw thread section G of the control rod part 1a, which surrounds the end section Ca of the coupling element 1c at least in sections in sleeve-like fashion. Analogously, the screw thread G in the end section Cb of the coupling element 1c meshes with the corresponding screw thread section G of the control rod part 1b, which surrounds the end section Cb of the coupling element 1c at least in sections in sleeve-like fashion.

A further suitably designed thread D is formed on the outer wall of the coupling element 1c in the central section thereof, with which thread D there meshes a pinion (not illustrated in the figures) which is connected by way of a steering spindle (not shown) to a steering wheel (not shown) for the driver of the vehicle. By rotating the steering wheel, the driver can thus, in the conventional manner, displace the control rod 1 in the vehicle transverse direction Q and thus steer the wheels by virtue of, in the present case, the two control rod parts 1a, 1b being displaced in the same direction by way of the coupling element 1c which is displaced (laterally) in the vehicle transverse direction Q by way of the pinion.

In the present case, each control rod part 1a, 1b is assigned a dedicated control motor 2a and 2b, respectively, in the form of electric motor. Each control motor 2a and 2b is connected to the associated control rod part 1a and 1b, respectively, by way of a ball screw 3, which is illustrated merely symbolically and thus not in any more detail. The outer side of each control rod part 1a, 1b is consequently designed such that the ball screw 3 that is set in motion by the respective control motor 2a and 2b displaces the respective control rod part 1a and 1b correspondingly in the vehicle transverse direction Q.

When the driver steers using the steering wheel and thus seeks to displace the coupling element in the transverse direction Q, and the two control motors 2a, 2b are suitably actuated by an electronic control unit which identifies the steering demand of the driver, it is initially possible for both control motors 2a, 2b to assist an equal displacement of the two control rod parts 1a, 1b by way of their torque. With equal dimensioning at each control rod part 1a, 1b, it is then the case that the two identical control motors 2a, 2b rotate at the same rotational speed, and each of the control motors 2a, 2b introduces half of the required assistance torque into the steering system. Alternatively, it is however also possible for the two control motors 2a, 2b, with identical dimensioning, to also rotate at different rotational speeds as described above, whereupon the two control rod parts 1a, 1b are displaced differently in the vehicle transverse direction Q. With suitable actuation of the control motors 2a, 2b, it is thus possible to maintain the Ackermann relationship for all steer angles of the vehicle. In the event of a failure of one control motor (2a, 2b), it is ultimately necessary, by way of suitable configuration of the ball screw 3 in conjunction with the screw threads G in the sections Ca, Cb, to ensure that at least a certain assistance torque can be introduced by way of a single control motor 1a or 1b, and both wheels can be steered in the conventional manner by the driver via the coupling element 1c. Furthermore, corresponding steering of the two vehicle wheels by way of the control motors 2a, 2b alone, without a displacement of the coupling element 1c by the driver, is also possible.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A steering system of a two-track vehicle, comprising:
a control rod displaceable transversely with respect to a vehicle longitudinal axis, two ends of the control rod being articulatedly connected with track rods that act on steerable wheels of the vehicle such that a displacement of the control rod pivots the steerable wheels about their steering axis of rotational, wherein
the control rod is split into two control rod parts assigned to, in each case, one wheel, and a coupling element by which the two control rod parts are connected to one another, the coupling element at least intermittently supporting the two control rod parts relative to one another and at least intermittently permitting a relative movement of the two control rod parts in a vehicle transverse direction,
the coupling element is connected by way of, in each case, one screw thread to the control rod parts, wherein a screw axis of rotation of the screw thread is a longitudinal axis of the control rod, and
the two control rod parts and/or the coupling element are rotatable about the longitudinal axis;
a steering spindle, which is connected to a steering wheel for a driver of the two-track vehicle, meshes with the coupling element such that a rotation of the steering spindle causes a displacement of the coupling element in the vehicle transverse direction.

2. The steering system according to claim 1, wherein
for at least a partial decoupling between the coupling element and the two control rod parts, which at least partial decoupling permits relative movement between the two control rod parts, a clutch element is provided, the clutch element being actuatable via an actuator.

3. The steering system according to claim 1, wherein each control rod part is assigned a dedicated motor for adjustment thereof.

4. The steering system according to claim 3, wherein the dedicated motor is an electric motor.

5. The steering system according to claim 4, wherein each dedicated motor acts via a ball screw on an associated one of the two control rod parts for displacement thereof.

6. The steering system according to claim 3, wherein each dedicated motor acts via a ball screw on an associated one of the two control rod parts for displacement thereof.
